(19) United States
(12) Patent Application Publication
(10) Pub. No.: US 2023/0363587 A1
(43) Pub. Date: Nov. 16, 2023

(54) KIEF COIN

(71) Applicant: Dylan Husted, Liverpool, NY (US)

(72) Inventor: Dylan Husted, Liverpool, NY (US)

(21) Appl. No.: 17/588,285

(22) Filed: Jan. 30, 2022

(51) Int. Cl. A47J 42/14

(52) U.S. Cl. CPC A47J 42/14

(57) ABSTRACT

The present invention is directed to a kief coin. The kief coin includes a pair of faces and a cylindrical shape. Each of the faces is generally smooth and free from blemishes. Further, the faces may include decorative indicia thereto. The kief coin device is useful for increasing kief yields in an herb grinder.

### FIELD OF THE INVENTION

This invention relates to grinding or pulverizing systems and methods. More particularly, it relates to a kief coin for use with an herb grinder.

### BACKGROUND

In general, tobacco and botanical herb grinders are cylindrical devices divided into two halves with sharp pegs or teeth aligned such that when the halves are rotated with respect to each other, the material inside is shredded. Herb grinders are made from wood, plastic, or metal, and may be manual or electric. They are commonly used for refining marijuana or tobacco, as well as in the kitchen for crushing spices and herbs.

To help increase kief production or grind yields, many users resort to placing a coin in the grinder which helps break more trichomes from the ground cannabis. Additionally, the weight of the coin also presses the fine resinous particles through the grinder down toward the kief catcher, further improving the kief yield. However, coins are inherently unsanitary and may not be available in the ideal size to increase kief production or trappings.

Accordingly, and in light of the foregoing, there exists a need for a means by which the functionality of a coin in an herb grinder can be improved upon. More specifically, it would be desirable for a sanitary and easy to use device that applies pressure within an herb grinder to help increase desired yields.

### BRIEF DESCRIPTION OF THE DRAWINGS

The advantages and features of the present invention will become better understood with reference to the following more detailed description and claims taken in conjunction with the accompanying drawings, in which like elements are identified with like symbols, and in which:

FIG. 1 is a perspective view of a kief coin 10, according to the preferred embodiment of the present invention;

FIG. 2 is a side elevation view of the kief coin 10, according to the preferred embodiment of the present invention;

FIG. 3 is a top plan view of the kief coin 10, shown in a utilized state, according to the preferred embodiment of the present invention; and,

FIG. 4 is an environmental view of the kief coin 10 in an exemplary method of use with a grinder 20, 30, according to the preferred embodiment of the present invention.

DESCRIPTIVE KEY

| | |
|---|---|
| 10 | kief coin |
| 11 | face |
| 12 | edge |
| 20 | grinder top |
| 25 | grinder portion |
| 26 | aperture |
| 30 | screen portion |
| 31 | screen |
| 35 | grinder bottom |

### DETAILED DESCRIPTION OF THE PREFERRED EMBODIMENTS

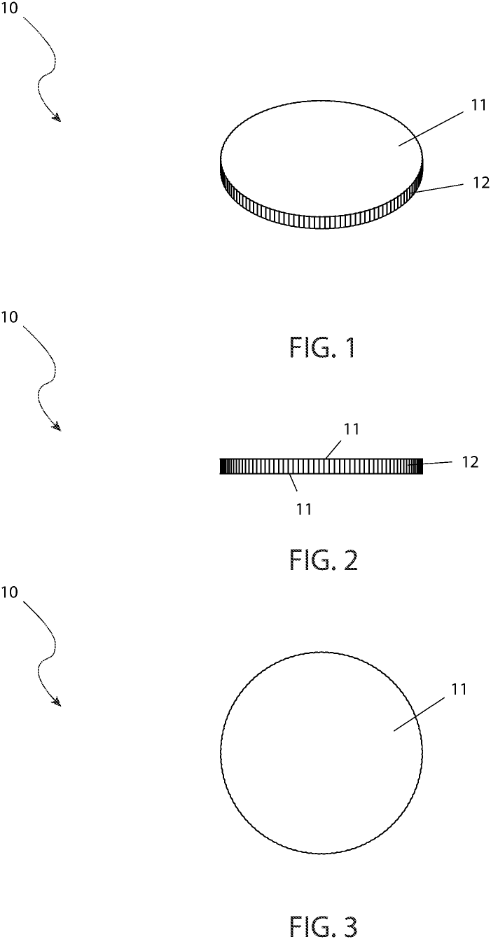

The best mode for carrying out the invention is presented in terms of its preferred embodiment, herein depicted within FIGS. 1 through 4. However, the invention is not limited to the described embodiment, and a person skilled in the art will appreciate that many other embodiments of the invention are possible without deviating from the basic concept of the invention and that any such work around will also fall under scope of this invention. It is envisioned that other styles and configurations of the present invention can be easily incorporated into the teachings of the present invention, and only one (1) particular configuration shall be shown and described for purposes of clarity and disclosure and not by way of limitation of scope. All of the implementations described below are exemplary implementations provided to enable persons skilled in the art to make or use the embodiments of the disclosure and are not intended to limit the scope of the disclosure, which is defined by the claims.

The terms “a” and “an” herein do not denote a limitation of quantity, but rather denote the presence of at least one (1) of the referenced items.

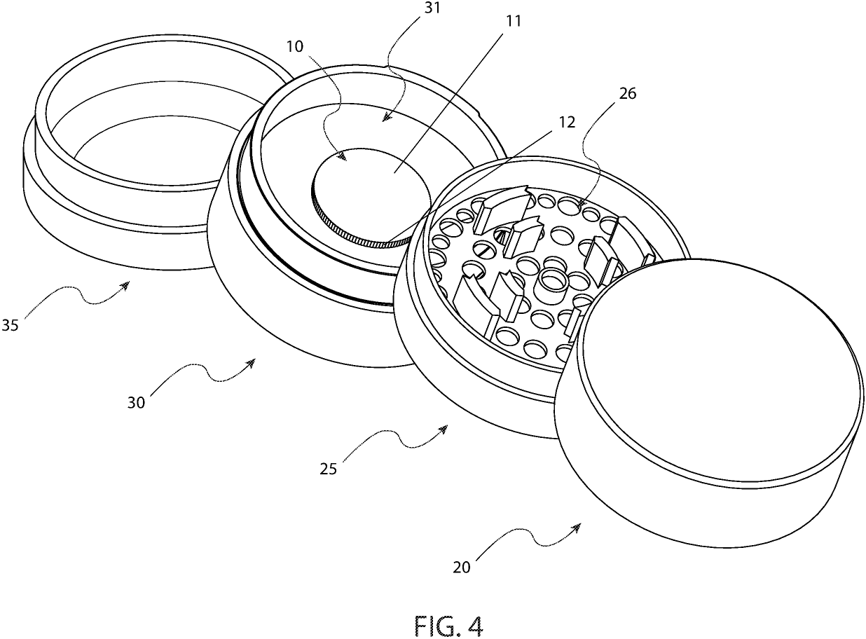

Referring now to FIG. 4, there is shown a kief coin 10 that aids in the collection and harvest of the kief that resides on the outside of the dried infructescence of cannabis as it in the process of being ground in a grinder assembly. Such a grinder assembly can include a grinder top 20, a grinder portion 25 that has protrusions that interact with protrusions on the grinder top 20 to grind material held therein to produce ground material that falls through apertures 26 of the grinder portion 25 to collect in a screen portion 31, which has a screen 31 that separates the screen portion 30 from a grinder bottom 35. The grinder top 20 and grinder bottom 35 also function as lids so that when the grinder top 20, grinder portion 25, screen portion 30, and grinder bottom 35 are assembled together, any material is held therein.

Now referring to FIGS. 1-3, the kief coin 10 is preferably a disc or a squat cylindrical shape that resembles coinage. The kief coin 10 includes a pair of faces 11 and an edge 12. The pair of faces 11 are preferably smooth and unblemished, but can include any embossing, carving, appliqués, cladding, or other decorative or indicia thereto. The edge 12 is preferably a knurled surface that may continuous or discontinuous and provides an aid for gripping the kief coin 10 during scraping of the kief through the screen 31 for further processing or collecting in the grinder bottom 35. The edge 12 may also be smooth as the faces 11.

The material of the kief coin 10 is preferably metallic to aid in thermal transfer when the grinder assembly with the ground herb is placed in a cold environment to aid in the collection and transfer of the kief with the kief coin 10, but may also be plastic. The material of the kief coin 10 preferably imparts no discernible flavor or impurities to the resultant collected kief. The kief coin 10 is anticipated to made available in multiple diameters and thicknesses depending on the size of the grinder assembly that is to be used. A typical exemplary size of a kief coin 10 would resemble that of a coin such as a U.S. quarter or half-dollar.

In an exemplary method of use, the kief coin 10 is then placed onto a screen 31 of a screen portion 30 of a standard multi-compartment grinder assembly. The presence of the kief coin 10 in the grinder assembly serves to further break down the kief from the dried infructescence of the cannabis. Additionally, the weight of the kief coin 10 helps to press the kief through the screen 31 into the grinder bottom 35. To further its efficiency, the kief coin 10 either placed in the grinder assembly or by itself may be placed in a cold environment such as a freezer or refrigerator before use. The cold temperature serves to make the kief more “brittle” and thus easier to break down. When finished with use, the kief coin 10 can be easily cleaned and sanitized as needed prior to subsequent use.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated.

1. A device for harvest of cannabis kief comprising:
a flat disk constructed to be placed on a screen contained in a rotating grinder assembly;
the disk constructed to cooperate with the screen to break down the kief from dried infructescence of the cannabis;
the disk and screen being located below grinder protrusions in the rotating grinder that initially grind the dried infructescence;
whereby, rotating the grinder results in the kief passing through the screen and exiting the bottom of the grinder.

2. The device of claim 1, wherein the disk is coin-shaped.

3. The device of claim 1, wherein the disk is substantially circular.

4. The device of claim 1, wherein the disk has smooth unblemished faces.

5. The device of claim 1, wherein the disk edge includes at least a partially knurled surface.

6. The device of claim 1, wherein the disk has a top and bottom face, and at least one of the top or bottom face includes embossing, carving, appliques or cladding.

7. The device of claim 1, wherein the disk is metal.

8. The device of claim 7, wherein the disk is configured to be chilled before use.

9. A device for harvest of cannabis kief comprising:
a flat, coin-shaped, substantially circular disk constructed to be placed on a screen contained in a rotating grinder assembly;
the disk constructed to cooperate with the screen to break down the kief from dried infructescence of the cannabis;
the disk and screen being located below grinder protrusions in the rotating grinder that initially grind the dried infructescence;
whereby, rotating the grinder results in the kief passing through the screen and exiting the bottom of the grinder.

10. The device of claim 9, wherein the disk has smooth unblemished faces.

11. The device of claim 9, wherein the disk edge includes at least a partially knurled surface.

12. The device of claim 9, wherein the disk has a top and bottom face, and at least one of the top or bottom face includes embossing, carving, appliques or cladding.

13. The device of claim 9, wherein the disk has a diameter of a United States quarter or half-dollar.

14. A method of recovering kief from dried infructescence of cannabis in a rotating grinder of the time having a grinder screen comprising:
chilling a flat metal coin-shaped disk;
disassembling the grinder;
placing the chilled disk on the grinder screen;
assembling the grinder;
loading the grinder with dried cannabis infructescence;
closing the grinder;
rotating the grinder;
collecting the kief in a compartment in the grinder or from the bottom of the grinder.

15. The method of claim 14, wherein the disk is substantially circular.

16. The method of claim 15, wherein the disk has a diameter of a United States quarter or half-dollar.

17. The method of claim 14, wherein the disk has smooth unblemished faces.

18. The method of claim 14, wherein the disk edge includes at least a partially knurled surface.

19. The method of claim 14, wherein the disk has a top and bottom face, and at least one of the top or bottom face includes embossing, carving, appliques or cladding.

20. The method of claim 14, further comprising manufacturing the disk in different diameters to fit different grinders.
